(19) United States
(12) Patent Application Publication
(10) Pub. No.: US 2023/0088409 A1
(43) Pub. Date: Mar. 23, 2023

(54) METHOD FOR BANDWIDTH MEASUREMENT IN AN OPTICAL FIBER

(71) Applicant: COMMSCOPE TECHNOLOGIES LLC, Hickory, NC (US)

(72) Inventors: Earl R. PARSONS, Allen, TX (US); William J. YOUNG, Plano, TX (US)

(73) Assignee: COMMSCOPE TECHNOLOGIES LLC, Hickory, NC (US)

(21) Appl. No.: 17/798,278

(22) PCT Filed: Feb. 12, 2021
(86) PCT No.: PCT/US2021/017917

§ 371 Date: Aug. 8, 2022

Related U.S. Application Data
(60) Provisional application No. 62/976,831, filed on Feb. 14, 2020.

(51) Int. Cl. G01M 11/00; H04B 10/073; H04B 10/2507

(52) U.S. Cl. CPC G01M 11/335; H04B 10/0731; H04B 10/2507

(57) ABSTRACT

The invention is directed to the characterization of an optical channel, such as an optical fiber, in an optical network. The method includes calibrating a transmitter by measuring its transmitter and dispersion eye closure (TDEC, in the case of non-return to zero optical (NRZ) optical systems or transmitter and dispersion eye closure quaternary (TDECQ, in the case of 4-level pulse amplitude modulation (PAM4) optical systems). That calibrated transmitter is used to characterize the optical channel being tested by providing a measure of its stressed eye closure (SEC) or stressed eye closure quaternary (SECQ). A loss deficit for the optical channel can be calculated by subtracting the SEC or SECQ value from the maximum TDEC or TDECQ value.

### CROSS-REFERENCE TO RELATED APPLICATION

This application is being filed on Feb. 12, 2021 as a PCT International Patent Application and claims the benefit of U.S. patent application Ser. No. 62/976,831, filed on Feb. 14, 2020, the disclosure of which is incorporated herein by reference in its entirety.

### FIELD OF THE INVENTION

The present invention is generally directed to optical communications, and more specifically to optical fibers and methods of measuring bandwidth of an optical fiber.

### BACKGROUND OF THE INVENTION

Optical fiber networks are becoming increasingly prevalent in part because service providers want to deliver high bandwidth communication and data transfer capabilities to customers. As optical networks become more complex, it has become increasingly important to manage optical signals in the network. One of the major parameters that network operators would like to know is the bandwidth of their network, including the bandwidth of each fiber cable installed in the network, as this limits the amount of information that can be transmitted over a given distance. A number of factors can affect the performance of a network, such as the optical power available, optical loss, and fiber bandwidth due to dispersion, both chromatic dispersion and, in the case of a multimode fiber channel, modal dispersion. The overall optical loss of the network can be affected by the number and quality of connectors and splices and the length of the fiber links, due to fiber attenuation. Additional factors considered by the network designer include limitations in the transmitter and the receiver bandwidth.

New standards for fiber networks were recently defined in IEEE 802.3 Clause 95.8.5 and Clause 121.8.5, which specify Transmitter and Dispersion Eye Closure (TDEC) standards, used in non-return-to-zero (NRZ) systems, and Transmitter and Dispersion Eye Closure Quaternary (TDECQ) standards, used in 4-level pulse amplitude modulation (PAM4) systems. These specifications incorporate considerations of chromatic dispersion in single mode fiber systems, and both chromatic and modal dispersion in multimode fiber systems.

There is a need to provide network owners the ability to determine bandwidths of existing fiber networks under these new standards to verify the bandwidths of newly installed fiber networks, so that they may be operated most efficiently.

### SUMMARY OF THE INVENTION

The present invention is directed to characterizing an optical channel, such as an optical fiber.

One embodiment of the invention is directed to a method of characterizing an optical channel that includes calibrating a 4-level pulse amplitude modulation (PAM4) optical transmitter by measuring its Transmitter and Dispersion Eye Closure Quaternary (TDECQ) as a function of bandwidth to produce a measured TDECQ curve. The Stressed Eye Closure Quaternary (SECQ) of the optical channel is measured using the calibrated PAM4 optical transmitter. The measured SECQ of the optical channel is compared against the TDECQ curve to determine a bandwidth of the optical channel.

Another embodiment of the invention is directed to a method of characterizing an optical channel that includes calibrating a Non Return to Zero (NRZ) optical transmitter by measuring its Transmitter and Dispersion Eye Closure (TDEC) as a function of bandwidth to produce a measured TDECQ curve. The Stressed Eye Closure (SEC) of the optical channel is measured using the calibrated NRZ optical transmitter. The measured SEC of the optical channel is compared against the TDEC curve to determine a bandwidth of the optical channel.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an embodiment of an optical network, to which the present invention may be applied;

FIG. 2 schematically illustrates a typical result of a Transmitter and Dispersion Eye Closure (TDEC) measurement, as set forth in the IEEE 802.3 Ethernet standard;

FIG. 3 schematically illustrates a typical result of a Transmitter and Dispersion Eye Closure Quaternary (TDECQ) measurement, as set forth in the IEEE 802.3 Ethernet standard;

FIG. 4 schematically illustrates an optical system that may be used for measuring Transmission and Dispersion Eye Closure (TDEC) and Transmission and Dispersion Eye Closure Quaternary (TDECQ) for an optical transmitter, according to an embodiment of the present invention;

FIG. 5 schematically illustrates loss as a function of signal frequency in a communications system operating at worst case fiber length and dispersion, showing the contribution from chromatic and modal dispersion, and receiver bandwidth;

FIG. 6 schematically illustrates loss as a function of signal frequency in a communications system operating with a fiber that is better than the worst-case fiber length and dispersion used for FIG. 5, showing the contribution from chromatic and modal dispersion, and receiver bandwidth;

FIG. 7 schematically illustrates a TDECQ curve as a function of fiber bandwidth and power budget, as may be used in the present invention;

FIG. 8A schematically illustrates an embodiment of a system used for characterizing an optical transmitter, as may be used in the present invention;

FIG. 8B schematically illustrates an experimental setup using a calibrated optical transmitter for measuring the bandwidth of an optical fiber;

FIG. 9A schematically illustrates an optical network having optical transceivers coupled via a network of two optical fibers that are connected together;

FIGS. 9B-9D schematically illustrate various steps in characterizing the bandwidth of the network of two optical fibers using a calibrated transmitter, according to an embodiment of the present invention; and

FIG. 10 schematically presents a graph showing how to look up the fiber bandwidth from an SECQ measurement using the measured TDECQ curve, according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to systems, devices, and methods that can provide benefits to optical communication networks. More particularly, the invention addresses issues relating to bandwidth in a fiber channel and how to measure the bandwidth so as to be able to optimize the performance of the optical system.

Optical networks have traditionally been designed using characteristics of the planned network, including such characteristics as the fiber link length and the number of connectors to be used. Typically, the link length is less than or equal to the maximum supported by the standard under which the network is operating. In such a case, two important considerations for the engineer designing the network include the IEEE link model and the internal connector losses.

Network performance models can be based on a number of characteristics of the network and the components that are included therein. For example, the model may include various transmitter parameters such as wavelength and optical pulse parameters such as 10%-90% risetime and interpulse jitter; fiber characteristics at the operating wavelength, such as refractive index, attenuation and dispersion (chromatic dispersion in the case of a single mode fiber and both chromatic and modal dispersion in the case of a multimode fiber); and receiver characteristics such as sensitivity, bandwidth, detected pulse risetime, eye opening and the like. The model may include penalty calculations, based on such parameters as the link length, dispersion, and the like, to produce a figure for the available power margin. The engineer may be able to trade off various network parameters. For example, for a specific transmitter that produces a particular signal, the network designer may be able to trade-off the number of connectors with the link length, permitting the network to include a greater number of connectors for a shorter link length, and vice versa.

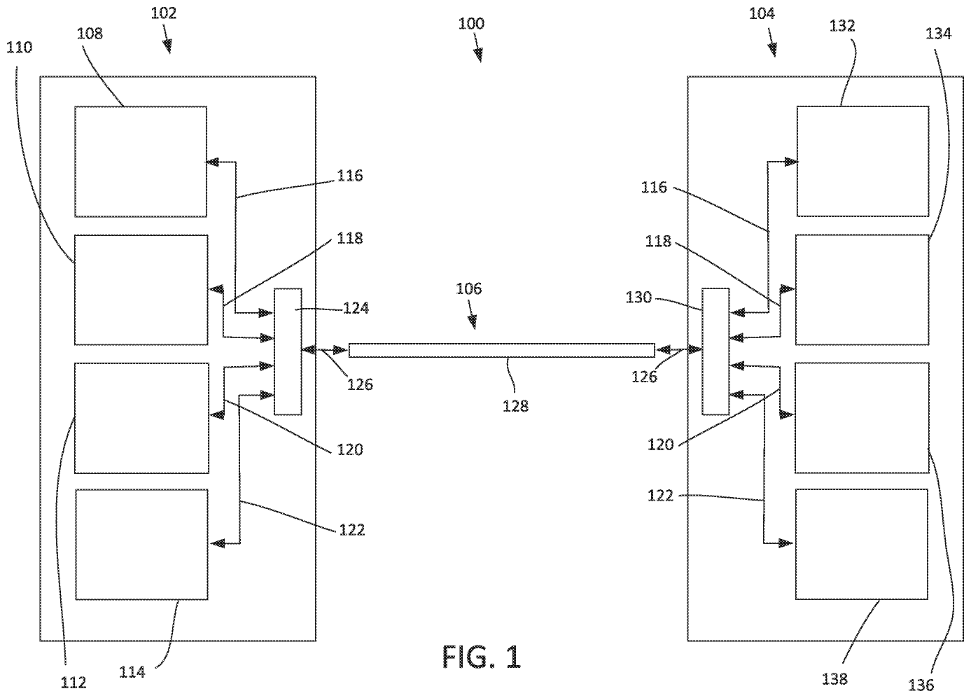

An exemplary embodiment of an optical communication system 100 is schematically illustrated in FIG. 1. The optical communication system 100 generally has a transmitter portion 102, a receiver portion 104, and a fiber optic portion 106. The fiber optic portion 106 is coupled between the transmitter portion 102 and the receiver portion 104 for transmitting an optical signal from the transmitter portion 102 to the receiver portion 104.

In this embodiment, the optical communication system 100 is of a wavelength division multiplexing (WDM) design. Optical signals are generated within the transmitter portion 102 at different wavelengths and are combined into the optical fiber portion 106 and transmitted to the receiver portion 104, where the signals that propagated at different wavelengths are spatially separated and directed to respective detectors. The illustrated embodiment shows an optical communication system 100 that WDMs four different signals, although it will be appreciated that optical communications systems may WDM different number of signals, e.g. two, three or more than four.

Transmitter portion 102 has multiple transmitter units 108, 110, 112, 114 producing respective optical signals 116, 118, 120, 122 at different wavelengths. The optical communication system 100 may operate at any useful wavelength, for example in the range 800-950 nm, or over other wavelength ranges, such as 1250 nm-1350 nm, 1500 nm-1600 nm, or 1600 nm-1650 nm. Each transmitter unit 108, 110, 112, 114 is coupled to the optical fiber system 106 via a wavelength division multiplexer/demultiplexer (“WDM mux/demux”) 124, that directs the optical signals 116, 118, 120, 122 at different wavelengths into the fiber 128 of the optical fiber system 106 as a combined signal 126. The combined signal 126 propagates along the optical fiber system 106 to the receiver portion 104, where it is split by a second WDM mux/demux 130 into the optical signals 116, 118, 120, 122, which are directed to their respective receiver units 132, 134, 136, 138.

In many optical communications systems there are optical signals propagating in both directions along an optical fiber. This possibility is indicated in FIG. 1, where the optical signals are designated with double-headed arrows. In such a case, the transmitter units and receiver units may be replaced by transceiver units that generate and receive signals that propagate the fiber 128 at different wavelengths. In other embodiments, there may be a separate transmitter unit and receiver unit for a signal at each end of the optical fiber system 106.

To increase the bit-rate of signals transmitted in optical communications systems, signal modulation has recently changed from non-return to zero (NRZ) modulation, that is based on optical signals at two different levels, to 4-level pulse amplitude modulation (PAM4) modulation, that uses optical signals at four different levels. Indicators of signal quality for conventional NRZ systems include transmitter and dispersion penalty (TDP) and the transmitter and dispersion eye closure (TDEC) indicator. With the advent of PAM4, there was a need for equivalent metrics for measuring signal quality.

TDEC is a characteristic of an equivalent transmitter and channel, assuming worst case fiber (length and dispersion). However, TDEC is useful because it estimates bit error rate (BER) based on eye diagrams, which result from a relatively quick measurement, compared to an actual measurement of BER: because the BER for an actual optical system is typically very low, e.g. around 10¹², measurement of BER can require a long measurement time. In addition, TDEC is independent of the receiver. A low-pass filter can be used to simulate the bandwidth of a reference receiver.

A new metric was established under the IEEE 802.3 Ethernet standard in 2018 for characterizing PAM4 systems, called transmitter and dispersion eye closure quaternary (TDECQ). The TDECQ standard is the equivalent of NRZ's TDEC standard, taking into account the use of four levels rather than two, and also recognizing that reference receivers mimic both the bandwidth and equalization capabilities of their real counterparts. Consequently, TDECQ is being developed for the assessment of the quality of transmitters used in high speed optical links and their interoperability between receivers. TDECQ is explained in greater detail in Echeverri-Chacon et al, “Transmitter and Dispersion Eye Closure Quaternary (TDECQ) and Its Sensitivity to Impairments in PAM4 Waveforms,” (2019) J. Lightwave Technology 37 852-860 (“the JLT article”), incorporated herein by reference. As will be seen herein, TDECQ may also be used for measuring the bandwidth of a fiber link.

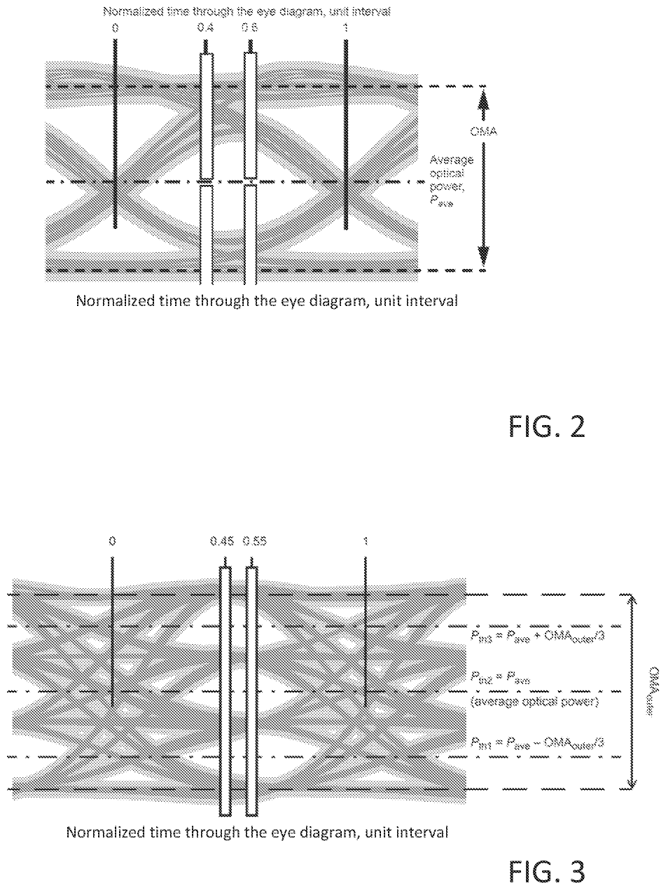

FIG. 2 schematically illustrates results of a TDEC measurement, as shown in the IEEE 802.3 Ethernet standard, Clause 95 incorporated herein by reference. In this case, rather than a single eye opening height measurement, as is the case with conventional NRZ eye closure measurements, the TDEC measurement uses the eye height at measured at normalized times 0.4 and 0.6 within the eye diagram unit interval, as discussed in IEEE 802.3 Ethernet standard, Clause 95.8.5. The optical modulation amplitude is represented by “OMA.” The figure also indicates the level or average optical power, Pₐᵥₑ.

FIG. 3 schematically illustrates results of a TDECQ measurement, as shown in the IEEE 802.3 Ethernet standard, Clause 121, incorporated herein by reference. In this case, rather than a single eye opening height measurement, the TDECQ measurement examines the separation between traces at normalized times 0.45 and 0.55 within the eye diagram unit time interval, as discussed in IEEE 802.3 Ethernet standard, Clause 121.8.5. The measurement also relies on three different power thresholds. Given the value of OMAₒᵤₜₑᵣ as being the optical power level between the zero level and the third level, as shown in the figure, the first power threshold Pₜₕ₁ is given by the average optical power minus one third of OMAₒᵤₜₑᵣ(Pₜₕ₁=Pₐᵥₑ−OMAₒᵤₜₑᵣ/3). The second power threshold, Pₜₕ₂ is simply the average power Pₐᵥₑ, while the third power threshold, Pₜₕ₃ is given by the average power plus one third of OMAₒᵤₜₑᵣ (Pₜₕ₃=Pₐᵥₑ+OMAₒᵤₜₑᵣ/3). These thresholds represent the decision boundaries between adjacent bit symbols (i.e. between 00 and 01, between 01 and 11, and between 11 and 10, for a grey coding).

TDECQ is used to provide a system-level predictor of transmitter performance without the need to use a BER tester. A TDECQ test estimates vertical eye closure after equalization, i.e. after effectively having been transmitted through a “worst case optical channel” and measured using a generic reference receiver. The definitions of a “worst case optical channel,” the expected effect of the reference receiver and the conditions for equalization are agreed upon in the standards community for specific applications. For example, the IEEE 802.3cd Ethernet Task Force has published IEEE Std 802.3cd-2018, which gives specifications for links operating in the short wavelength (SR) window of 850 nm using multimode fibers (MMF) under 100 m. Also, the IEEE 802.3bs Ethernet Task Force. has published IEEE Std 802.3bs-2017 with specifications for datacenter (DR) and longer (LR) links operating in the 1310 nm low dispersion window using single mode fiber links having a length from 500 m (200GBASE-DR4) up to 10 km (200GBASE-LR4). There are similar standards for TDEC.

A TDECQ test estimates the symbol error rate (SER) based on the statistics of the signal, rather than counting decision errors to produce a SER value. Noise addition and SER estimation are computed for each iteration of the feed forward equalizer (FFE) and equalization deviation, σ_{eq}, search based on two vertical histograms taken from a PAM4 eye diagram, taken at times near 0.45 and 0.55 within the unit time interval, as shown in FIG. 3. This compensates for sampling inaccuracies and jitter that move the decision time in real receivers. The histograms are averaged from narrow vertical windows of samples to support the use of a sampling oscilloscope.

The precise time position, t, is adjusted to minimize TDECQ while keeping the histograms spaced 0.1 unit time interval apart. Each histogram is processed to combine the signal traces with noise by means of a convolution with a Gaussian distribution whose standard deviation is σ_{eq}. The result is a probability density function (PDF) representing the probability distribution of the four symbol levels (Vi), where i=0, 1, 2, 3. The SER for each eye can then be estimated from the PDF by summing the histogram tails that fall on the wrong side of each threshold. The TDECQ machine discussed below uses cumulative PDFs to estimate the SER. A similar approach is used to determine the SER using TDEC for NRZ systems.

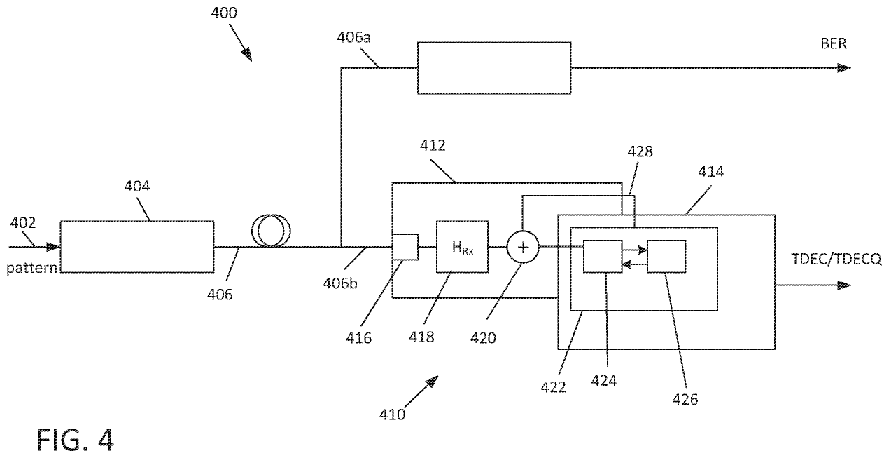

FIG. 4 schematically illustrates an embodiment of a system 400 that may be used in the measurement of TDEC and TDECQ. A signal pattern 402, for example in the form of an RF signal, is input to the optical transmitter 404, which encodes the signal pattern onto an optical signal and transmits the optical signal into an optical fiber 406. In some instances the optical fiber 406 may be a short length of fiber, for example around one meter or so. In such a case, the optical fiber 406 contributes very little loss or dispersion to the system, and measurements may be made primarily on the optical transmitter 404. In other instances the optical fiber 406 may be significantly longer, for example a hundred meters or more, several hundreds of meters or even more than one kilometer. In these cases where the optical fiber 406 is long enough to significantly affect the optical signal via attenuation and dispersion, the measurement system can characterize the optical fiber 406 too. The optical fiber is split into two branches, 406a, 406b. The first branch 406a is directed to an optical receiver 408, from which it is possible to measure the bit error rate (BER).

The second branch 406b is directed to the TDECQ (or TDEC) receiver 410, which includes a reference receiver 412 and a TDECQ (or TDEC) machine 414. The reference receiver 412 includes an optical-to-electrical converter 416, such as a photodiode, that detects the optical signal from the second optical fiber branch 406b, converting it to an electrical signal. The electrical signal is directed to a filter 418, having a filter function, H_{Rx}, that emulates the worst case fiber and receiver bandwidth. The filter 418 may be a fourth order Bessel-Thomson (BT4) filter. The filtered signal from the filter 418 is passed to a combiner 420 that adds a noise signal, described later.

The output from the combiner 420 is directed out of the reference receiver 412 to the TDECQ (or TDEC) machine 414, where it enters an optimization module 422 having a forward feedback equalizer (FFE) 424, for example a 5-tap FFE, and a noise search module 426. The (FFE) 424 and the noise search module 426 work together in such a way that the optimization module 422 imitates an equalizer in a receiver. The FFE 424 produces an equalization coefficient, C_{eq}, and the noise search module 426 produces an equalization deviation, σ_{eq}. The optimization module 422 produces an output 428, GG (=σ_{eq}/σ_{eq}), which is fed into the combiner 420 as an added noise signal. Thus, the optical signal passing along the second branch 406b is filtered in filter 418, noise is added in combiner 420 and is then equalized electronically in the optimization module 422.

The output from the TDECQ (or TDEC) machine 414 is the TDECQ (or TDEC) signal, which is given by σ_{ideal}/σ_{G}, where σ_{ideal} is the noise from an ideal transmitter. Thus, the TDECQ (and TDEC) signal is a measure of how much more noise could be added if using an ideal transmitter. Thus, the total power budget for a signal passing along a PAM4 optical network, PB (dB), is the sum of the insertion loss (i.e. fiber attenuation and connector loss), the TDECQ, and any additional insertion loss. Such a system is described in greater detail in the JLT article, incorporated herein by reference.

A similar system and approach can be used for making a measurement of TDEC in a NRZ optical network. Thus, the total power budget for a signal passing along a NRZ optical network, PB (dB) is the sum of the insertion loss (i.e. fiber attenuation and connector loss), the TDEC and any additional insertion loss.

Faced with the task of producing a design for an optical network, the network designer recognizes that certain parameters are outside his or her control, such as standard published TDEC/TDECQ values, transmitter quality, receiver equalizer and receiver bandwidth. However, other parameters are within the control of the designer including connector loss, fiber attenuation and fiber dispersion (chromatic dispersion for single mode systems and both modal and chromatic dispersion for multimode systems).

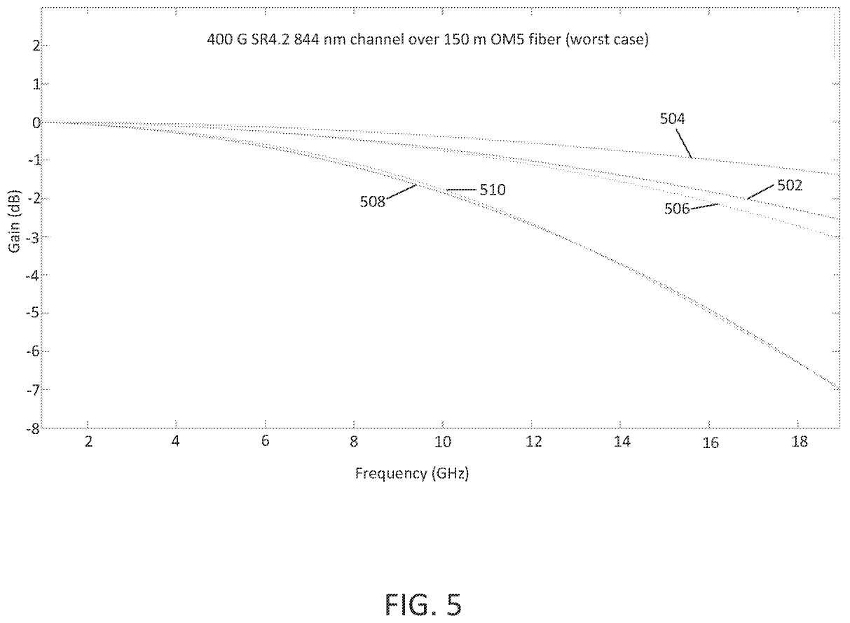

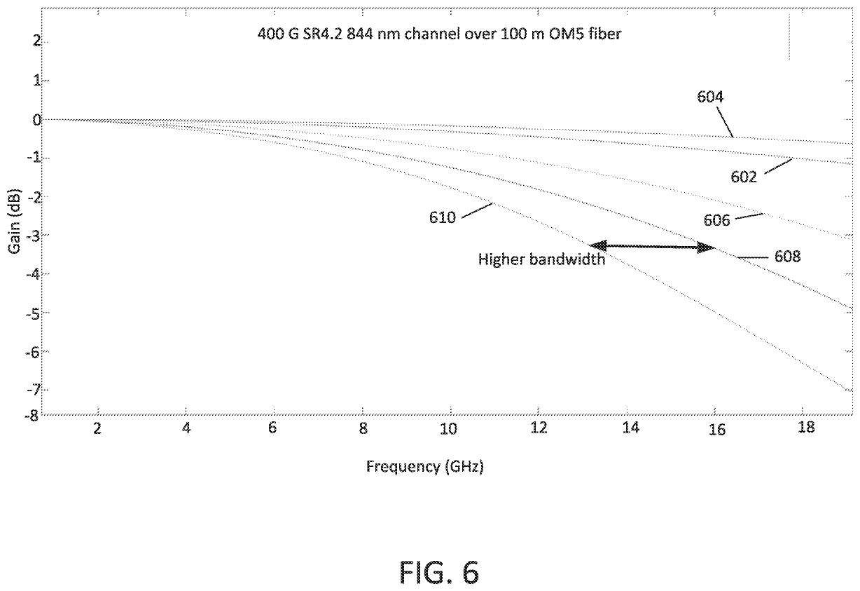

The fiber dispersion and receiver bandwidth determine the overall bandwidth of the optical network. This can be understood with reference to FIGS. 5 and 6, which show results from numerically modeling an optical 400G SR4.2 network over an OM5 multimode optical fiber. FIG. 5 shows curves of gain as a function of frequency corresponding to various losses in the network using a “worst case” 150 m length of OM5 fiber: curve 502 corresponds to the chromatic dispersion, curve 504 to the modal dispersion and curve 506 to the receiver bandwidth. The total loss, calculated from adding the losses from the chromatic and modal dispersion, and the receiver bandwidth, is shown as curve 508. In comparison, the maximum loss according to TDECQ is shown as curve 510. In this case, the total loss curve 508 tracks closely with the TDECQ curve 510.

It will be appreciated that it is possible to produce a similar set of curves using a numerical model of a NRZ system, using a “worst case” length of fiber.

In comparison, FIG. 6 shows the corresponding curves of gain as a function of frequency using a fiber that is shorter than the worst case. Curve 602 corresponds to the chromatic dispersion, curve 604 to the modal dispersion, curve 606 to the receiver bandwidth, the summed total loss of the first three curves is shown as curve 608, while the maximum loss according to TDECQ is shown as curve 610. In this case, the fiber length is less than “worst case” and is assumed to be 100 m. The total loss curve 608 lies significantly above the TDECQ curve 610. This difference between the total loss 608 and the TDECQ 610 means that the optical system may add bandwidth while still maintaining compliance with the TDECQ.

It will be appreciated that it is possible to produce a similar set of curves using a numerical model of a NRZ system, where the fiber length is less than “worst case.”

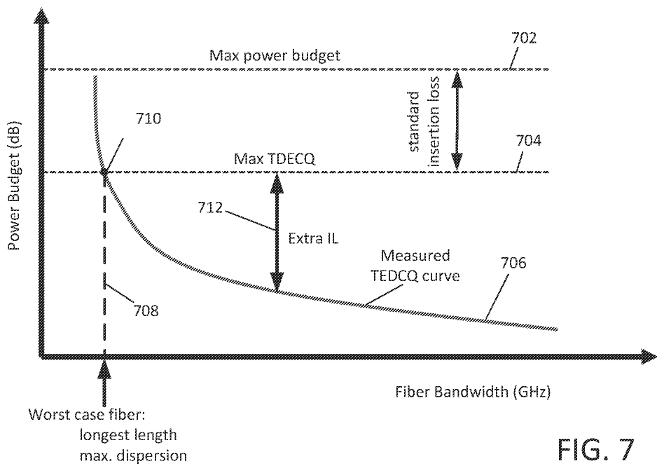

FIG. 7 shows that the relationship between TDECQ and bandwidth can yield extra margin for insertion loss if a worst case fiber is not used. The graph schematically illustrates power budget (in dB) as a function of fiber bandwidth (in GHz). The maximum available power budget is shown by the upper horizontal dashed line, 702. Once standard insertion losses are removed from the available power, the available maximum TDECQ is shown by the lower horizontal dashed line 704. The values of available power and maximum TDECQ, lines 702 and 704 are constant with fiber bandwidth, i.e. they are independent of fiber bandwidth, at least to first order.

The measured TDECQ curve 706, represents the value of TDECQ as a function of fiber bandwidth, which can be obtained empirically. At low fiber bandwidth, the TDECQ is higher, and at higher fiber bandwidth the TDECQ is lower. At the point of lowest available fiber bandwidth, taking into account the longest fiber length and maximum fiber dispersion, as set by the standard, the TDECQ plus the insertion losses equal the maximum power budget. In other words, the worst case fiber bandwidth is shown by the vertical dashed line 708. This corresponds to the point 710 where the TDECQ plus the standard insertion losses are equal to the TEDCQ.

Operating at higher bandwidth, for example with shorter fiber or lower dispersion, permits the network designer to select an operating TDECQ to the right of the vertical dashed line 708. The gap 712 between the TDECQ curve 706 and the maximum TDECQ 704 corresponds to additional insertion loss (IL) that the designer can introduce to the optical network. For example, by using a fiber of reduced dispersion, a longer fiber length may be used than is permitted by the standard, which assumes a maximum fiber length at a maximum dispersion. Also, selecting a fiber that is shorter than the what the standard is based on means that a more dispersive fiber may be used. Furthermore, a combination of shorter fiber length and/or reduced dispersion may result in the gap 712, which provides an additional insertion loss budget, which may be used for e.g. additional optical devices such as wavelength multiplexing/demultiplexing (WDM), add/drop filters, splitter and taps for performance monitoring, and additional fiber connectors to maximize link design flexibility, and the like.

It will be appreciated that a curve for TDEC may similarly be obtained experimentally over a range of bandwidths, and that at increased bandwidth, the TEDC is reduced, which corresponds to additional insertion loss (IL) that the designer can introduce to the optical network.

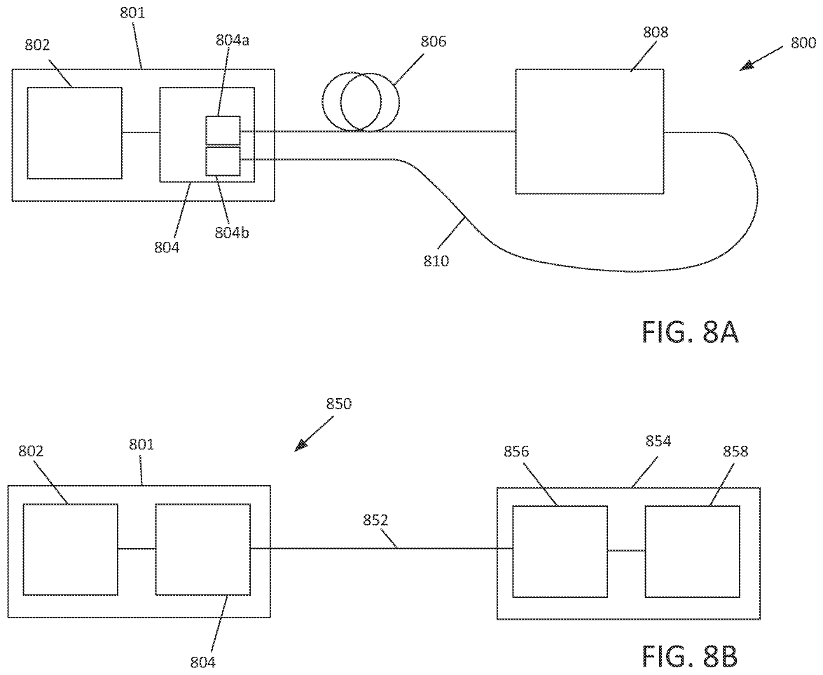

Bandwidth measurements of optical fibers, including optical fibers in installed optical networks, can be made based on a consideration of the TDECQ (or TDEC), as discussed above. The performance of such measurements first requires the characterization of the transmitter that is going to be used. FIG. 8A schematically illustrates how a transmitter may be characterized. The test transmitter 801 comprises two parts. The first part is a bit error ratio tester (BERT) 802 that produces an electrical signal, sometimes referred to as the pattern, that is to be transmitted optically. BERTs are commercially available as test equipment for communications systems, including optical communications systems, and are available, for example, from Keysight Technologies Santa Rosa, Calif., and are available at speeds of 10, 40, 100 or 400 Gb/s.

The BERT 802 feeds the pattern to an optical transceiver 804, for example Innolight T-OS8FNS-HOO 400G-SR8 transceiver, available from Innolight Technology USA, Inc., Santa Clara Calif. The transceiver 804 transmits a corresponding optical signal from its transmitter unit 804a into a primary optical fiber 806 whose bandwidth has been previously established. The fiber bandwidth is dependent on the modal dispersion (in the case of a multimode fiber) and the chromatic dispersion determine the fiber bandwidth, and inversely scales with fiber length. The primary optical fiber may be any length long enough to impact the signal. The output from the fiber 806 is passed through a variable attenuator 808 and then back to a receiver unit 804b of the transceiver 804 via a return fiber 810. The return fiber 810 is preferably short compared to the primary fiber 806, so that the characteristics of the optical signal received at the transceiver 804 are substantially the result of propagation through the primary fiber 806, rather than through the return fiber 810. A separate transmitter and receiver may be used in place of the transceiver 804. When testing multimode fibers, it is preferred that the transceiver, or transmitter, produces an output having an encircled flux that is compliant with IEC 61280-1-4, so that the transmitting modes of the multimode fiber are excited in a repeatable manner.

Since the bandwidth of the primary fiber 806 is known, it is possible to calculate a corresponding TDECQ. The insertion loss of the variable attenuator 808 can be varied to measure the ‘extra IL’ for the operating position. Thus, it is possible to measure the margin above the forward error correction (FEC) limit, which provides a calibration of the test transmitter 801.

Once the transmitter 801 has been calibrated, it may be used to measure the bandwidth of another fiber, for example using the experimental setup 850 shown in FIG. 8B. The test transmitter 801, comprising the BERT 802 and the transceiver 804, is attached to a first end of the fiber 852 under test. An analyzer unit 854 is coupled at the other end of the fiber 852. The analyzer unit 854 includes an optical-to-electrical converter 856, such as a photodiode, coupled to an analyzer module 858 comprising an oscilloscope. For applications involving 100G or 400 G signals, a photodiode such as Keysight 86105D may be used, and an oscilloscope such as Keysight 86100d may be used, both available from Keysight Technologies, Santa Rosa, Calif. The analyzer module 858 is provided with different filter bandwidth settings, which permit the TDECQ to be measured. Knowing the characteristics of the transmitter 801, the variation in attenuation provided by the analyzer module 858 permits measurement of the TDECQ, from which the fiber bandwidth may be obtained using the known relationship between fiber bandwidth and TDECQ. Fiber bandwidth measurements of this kind may be performed in a laboratory setting to characterize a fiber before it is installed in the field. Importantly, however, fiber bandwidth measurements may also be performed on optical fibers that are already installed in optical networks, simply by coupling the calibrated transmitter 801 at one end of the fiber 852 and the analyzer unit 854 at the other.

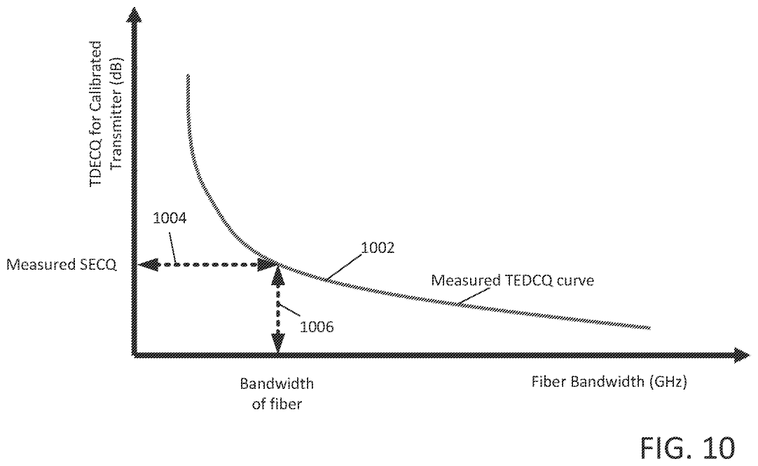

This approach may also be used to perform a step-wise characterization of a network that comprises a number of fibers, connectors and the like. For this characterization, the stressed eye closure quaternary (SECQ) is measured. TDECQ is used to characterize the bandwidth of a transmitter, where the filter function, H_{Rx}, represents both the worst case fiber and the receiver bandwidth. Typically a TDECQ measurement, typically presented as a value with units of dB of optical power (dBo) involves only a small length of fiber, around 1 m or so, which does not limit the measurement. On the other hand, in the SECQ measurement the filter H_{Rx} only represents the receiver bandwidth, not the fiber. The SECQ measurement is also presented in dBo. Therefore, since the transmitter 801 has been calibrated, the bandwidth of the fiber being measured can be determined by comparing the measured SECQ and the measured TDECQ curve (shown in FIG. 7). If the SECQ measurement is the same as the max TDEDQ, then the fiber properties are the same as the assumed worst case fiber. Typically, however, the measured SECQ value is less than the maximum TDECQ value, especially if the accumulated dispersion (length×dispersion) of the fiber under test is less than that of the worst case fiber. Thus, the difference between maximum TDECQ and the measured SECQ measurements, referred to here as loss deficit, LD, is due to the difference in the accumulated dispersions of the worst case fiber and the fiber under test. In other words, LD (dBo)=max. TDECQ (dBo)—SECQ (dBo). The bandwidth of the fiber may be obtained using the measured TDECQ curve discussed above with regard to FIG. 7. As shown in FIG. 10, which shows the measured TDECQ curve 1002 as a function of bandwidth, the bandwidth of the fiber being measured is obtained by comparing the measured value of the SECQ, shown as dotted line 1004. The fiber bandwidth, shown as dotted line 1006 is value of bandwidth that corresponds to the measured value of SECQ on the TDECQ curve 1002.

The loss deficit may be used by the network designer to add additional connectors or other elements to an optical network that still complies with the IEEE standards, or to trade connector loss for fiber dispersion in link loss calculations for the optical fiber network.

This approach may also be used to perform a step-wise characterization of a NRZ network. For this characterization, the stressed eye closure (SEC) is measured. TDEC is used to characterize the bandwidth of the transmitter, where the filter function, H_{Rx}, represents both the worst case fiber and the receiver bandwidth. Typically a TDEC measurement, presented as a value with units of dB of optical power (dBo) involves only a small length of fiber, around 1 m or so, which does not limit the measurement. On the other hand, in the SEC measurement the filter H_{Rx} only represents the receiver bandwidth, not the fiber. The SEC measurement is also presented in dBo. Therefore, since the transmitter 801 has been calibrated, the bandwidth of the fiber being measured can be determined from the difference between the SEC and the TDEC measurements. If the measured SEC and maximum TDEC are the same, then the fiber properties are the same as the assumed worst case fiber. Typically, however, the SEC value is less than the maximum TDEC value, especially if the accumulated dispersion (length×dispersion) of the fiber under test is less than that of the worst case fiber. Thus, the difference between maximum TDEC and measured SEC measurements, also referred to as loss deficit (LD), is due to the difference in the accumulated dispersions of the worst case fiber and the fiber under test. In other words, LD (dBo)=max. TDEC (dBo)—SEC (dBo). The bandwidth of the fiber may be obtained using the measured TDEC curve, like that discussed above with regard to the TDECQ curve FIG. 7. The bandwidth of the fiber being measured can be looked up from the measured SEC using the measured TDEC curve, in a manner like that discussed above for the PAM4 system with reference to FIG. 10.

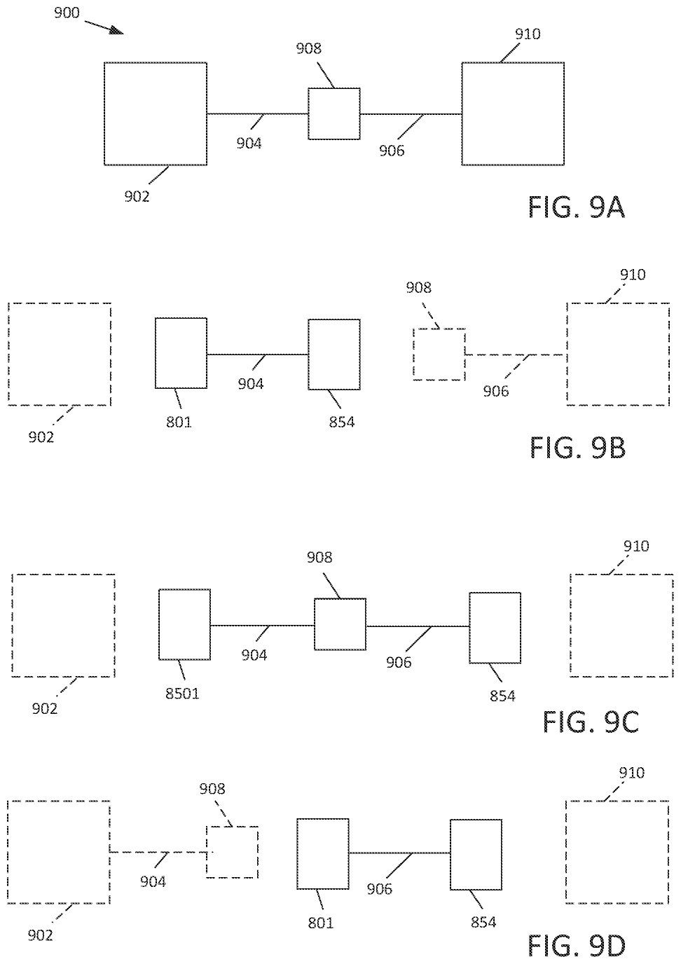

For example, an exemplary optical network 900, illustrated in FIG. 9A, includes a first transceiver 902 coupled to a first fiber 904. The first fiber 904 is connected to a second fiber 906 via a connector 908. The second fiber 906 is also connected to a second transceiver 910. In a first step, schematically illustrated in FIG. 9B, the bandwidth of the first fiber 904 may be obtained using the method just described, by disconnecting the first transceiver 902 and the connector 908, and attaching a calibrated transmitter 801 at the first end of the first fiber 904 and the analyzer unit 854 at the other end. Components of the network 900 not under test are shown in dashed lines.

In an optional second step, the first and second fibers 904, 906 be reconnected to the first fiber, and the analyzer unit 854 placed after the second fiber 906, as shown in FIG. 9C. The resulting SECQ measurement gives information on not only the first fiber 904, whose bandwidth was characterized in the previous step, but also the connector 908 and the second fiber 906. Since the first fiber 904 was characterized in the step shown in FIG. 9B, its characterization may be subtracted from the that of the fiber/connector/fiber combination 904/908/906 to give the characterization of the connector 908 and the second fiber 906.

In another approach, the transmitter 801 and analyzer unit 854 may be used to measure the bandwidth of the different lengths of fiber in a network in separate measurements. For example, in the case of the network 900 having two optical fibers that are connected, the bandwidth of the first fiber 904 may be measured using the approach shown in FIG. 9B and the bandwidth of the second fiber 906 measured by connecting the transmitter 801 and analyzer unit 854 to either end of the second fiber 906.

Thus, using the techniques described above, the bandwidth of a fiber, or combination of fibers, already installed in a fiber network may be determined for characterization of the network.

It will be appreciated that a similar approach may be used for determining the characteristics of an optical fiber used in an NRZ optical network, by calibrating a transmitter using TDEC and using that calibrated transmitter in a measurement of the optical fiber to generate an SEC measurement. In such a case, the loss deficit, LD, is given by the difference between the TDEC and SEC measurements.

Various modifications, equivalent processes, as well as numerous structures to which the present invention may be applicable will be readily apparent to those of skill in the art to which the present invention is directed upon review of the present specification. The claims are intended to cover such modifications and devices.

As noted above, the present invention is applicable to optical communication and data transmission systems, including active optical switch systems. Accordingly, the present invention should not be considered limited to the particular examples described above, but rather should be understood to cover all aspects of the invention as fairly set out in the attached claims.

What is claimed as the invention is:

1. A method of characterizing an optical channel, comprising:
calibrating a 4-level pulse amplitude modulation (PAM4) optical transmitter by measuring its Transmitter and Dispersion Eye Closure Quaternary (TDECQ) as a function of fiber bandwidth to produce a measured TDECQ curve;
measuring Stressed Eye Closure Quaternary (SECQ) of the optical channel using the calibrated PAM4 optical transmitter;
comparing the measured SECQ of the optical channel against the measured TDECQ curve to determine a bandwidth of the optical channel.

2. The method as recited in claim 1, wherein the optical channel is a single optical fiber.

3. The method as recited in claim 1, wherein the optical channel comprises at least a first length of optical fiber connected via a connector or a splice to a second length of optical fiber.

4. The method as recited in claim 1, wherein measuring the TDECQ of the PAM4 optical transmitter comprises passing a signal from the PAM4 optical transmitter through a first optical fiber of known dispersion and a first variable attenuator to a receiver.

5. The method as recited in claim 4, wherein the PAM4 optical transmitter is a transmitter unit of an optical transceiver and the receiver is a receiver unit of the optical transceiver.

6. A method of characterizing an optical channel, comprising: calibrating a Non Return to Zero (NRZ) optical transmitter by measuring its Transmitter and Dispersion Eye Closure (TDEC) as a function of fiber bandwidth to produce a measured TDEC curve;
measuring Stressed Eye Closure (SEC) of the optical channel using the calibrated NRZ optical transmitter;
comparing the measured SEC of the optical channel against the measured TDEC curve to determine a bandwidth of the optical channel.

7. The method as recited in claim 6, wherein the optical channel is a single optical fiber.

8. The method as recited in claim 6, wherein the optical channel comprises at least a first length of optical fiber connected via a connector to a second length of optical fiber.

9. The method as recited in claim 6, wherein measuring the TDEC of the NRZ optical transmitter comprises passing a signal from the NRZ optical transmitter through a first optical fiber of known dispersion and a first variable attenuator to a receiver.

10. The method as recited in claim 9, wherein the NRZ optical transmitter is a transmitter unit of an optical transceiver and the receiver is a receiver unit of the optical transceiver.

11. The method as recited in claim 4, wherein the first optical fiber is a multimode fiber and calibrating the PAM4 optical transmitter comprises generating an output from the PAM4 optical transmitter that is compliant with IEC 61280-1-4.

12. The method as recited in claim 9, wherein the first optical fiber is a multimode fiber, and calibrating the NRZ optical transmitter comprises generating an output from the NRZ optical transmitter that is compliant with IEC 61280-1-4.
